(19) United States
(12) Patent Application Publication
(10) Pub. No.: US 2026/0166483 A1
(43) Pub. Date: Jun. 18, 2026

(54) SYSTEMS AND METHODS FOR MOISTURE ENHANCED CARBON DIOXIDE DESORPTION FOR DIRECT AIR CAPTURE

(71) Applicants: SOOSAN KIM, New York, NY (US); ROBERT J. FARRAUTO, Princeton, NJ (US); The Trustees of Columbia University in the City of New York, New York, NY (US)

(72) Inventors: SOOSAN KIM, New York, NY (US); ROBERT J. FARRAUTO, Princeton, NJ (US)

(73) Assignee: The Trustees of Columbia University in the City of New York, New York, NY (US)

(21) Appl. No.: 19/532,645

(22) Filed: Feb. 6, 2026

Related U.S. Application Data
(63) Continuation-in-part of application No. PCT/US2024/041037, filed on Aug. 6, 2024.
(60) Provisional application No. 63/531,154, filed on Aug. 7, 2023.
(60) Provisional application No. 63/532,201, filed on Aug. 11, 2023.
(60) Provisional application No. 63/672,813, filed on Jul. 18, 2024.
(60) Provisional application No. 63/976,411, filed on Feb. 5, 2026.

(51) Int. Cl. B01D 53/62; B01D 53/81

(52) U.S. Cl. CPC B01D 53/62; B01D 53/81; B01D 2251/304; B01D 2253/104; B01D 2255/1026; B01D 2255/20753; B01D 2257/504; B01D 2258/06

(57) ABSTRACT

A substrate is provided for the capture, desorption, and collection of carbon dioxide from gaseous media with improved yield and overall efficiency. The substrate includes sorbents composed of alkali-containing compounds such as K₂O and Na₂O, nano-dispersed on metal oxide carriers such as porous Al₂O₃, in the presence of catalysts such as nickel or ruthenium. CO₂ is adsorbed from gases, including ambient air, contacted with the substrate. The CO₂ is then desorbed via contact with a moist inert gas desorption medium. Exemplary embodiments using nitrogen gas (N₂) having between 1 mol % and 2 mol % moisture content desorbed significantly more CO₂ between 150° C. and 200° C., and at a higher rate, compared to dry desorption conditions and elevated temperatures. Realizing these benefits at lower temperatures and at the vapor pressure of water at 25° C. for CO₂ desorption decreases the energy costs associated with direct air capture of carbon dioxide.

### CROSS-REFERENCE TO RELATED APPLICATIONS

This application is a continuation-in-part of International Patent Application No. PCT/US2024/041037, filed Aug. 6, 2024, which claims the benefit of U.S. Provisional Patent Application Nos. 63/531,154, filed Aug. 7, 2023; 63/532,201, filed Aug. 11, 2023; and 63/672,813, filed Jul. 18, 2024, which are incorporated by reference as if disclosed herein in their entireties. This application also claims the benefit of U.S. Provisional Patent Application No. 63/976,411, filed Feb. 5, 2026, which is incorporated by reference as if disclosed herein in its entirety.

### STATEMENT REGARDING FEDERALLY SPONSORED RESEARCH AND DEVELOPMENT

This invention was made with U.S. Government support under Grant Number DE-FE0032118 awarded by the United States Department of Energy. The United States Government has certain rights in the invention.

### BACKGROUND

Increasing carbon dioxide (CO₂) levels are recognized as a significant contributor to climate change due to the increasing concentrations in the atmosphere (about 423 ppm in 2024). In order to abate climate change, humanity must begin removing carbon dioxide from the atmosphere, e.g., using carbon capture and storage (CCS).

Direct air capture (DAC) is an emerging technology to abate human-induced climate change through the direct removal of CO₂ from the atmosphere in an effort to reduce CO₂ to pre-industrial revolution levels of 280 ppm. DAC technology has developed in various ways, including the use of highly absorbent amines, metal organic frameworks (MOFs), alkaline materials, ion exchange processes, electrochemical processes, and membranes. It is challenging to capture CO₂ directly from air due to the low concentration and excessive amounts of particulate matter, moisture, nitrogen, and oxygen. Further, impurities such as sulfur can deactivate and render sorbents useless through poisoning mechanisms.

Additionally, the cost for DAC is high at least due to energy-intensive processes of separating captured CO₂, e.g., from the aqueous containing amines solvents. According to the World Resources Institute, the reported range of costs for DAC varies between $250 and $600 per ton of CO₂. A large-scale facility in Iceland for Climeworks (Mammoth) suggests $600 per ton of CO₂ for DAC.

What is desired, therefore, are systems and processes that decrease DAC energy costs, increasing its viability as a tool for mitigating climate change.

### SUMMARY

Aspects of the present disclosure are directed to a method for capture of carbon dioxide. In some embodiments, the method includes providing a substrate including one or more sorbents, contacting a gaseous stream, e.g., ambient air, with the substrate; adsorbing an amount of the concentration of carbon dioxide to the one or more sorbents; preparing a desorption medium including an inert gas and an amount of moisture to desorb the carbon dioxide; contacting the substrate with the desorption medium; and applying heat, vacuum, or combinations thereof to the substrate, resulting in desorption of carbon dioxide from the substrate. In some embodiments, the substrate is heated to a temperature between about 75° C. and about 200° C. In some embodiments, the substrate is heated to a temperature of about 150° C. After desorbing carbon dioxide from the sorbents, e.g., into the desorption medium, a carbon dioxide product stream can be isolated from the desorption medium. An amount of the carbon dioxide product stream can be contacted with a concentration of hydrogen gas (H₂) in a hydrogenation bed. In some embodiments, the hydrogenation bed includes one or more catalysts disposed on a metal oxide carrier. In some embodiments, a concentration of a hydrocarbyl product is evolved at the hydrogenation bed, which can also be isolated as a hydrogenation product stream including a concentration of hydrocarbyl products evolved at the hydrogenation bed. In some embodiments, at least some of the desorption medium including inert gas to the substrate after separating out an amount of the carbon dioxide product stream. In some embodiments, the hydrocarbyl product includes methane, methanol, carbon monoxide, or combinations thereof.

In some embodiments, the moisture content of the desorption medium is greater than about 1 mol %, e.g., about 2 mol %. In some embodiments, the one or more sorbents include a metal oxide compound capable of adsorbing carbon dioxide, e.g., CeO₂, dispersed on a metal oxide carrier. In some embodiments, the one or more sorbents includes an alkali-containing compound dispersed on the metal oxide carrier; the gaseous stream including a concentration of carbon dioxide. In some embodiments, the inert gas includes nitrogen gas (N₂). In some embodiments, the alkali-containing compound includes oxides of potassium, oxides of sodium, or combinations thereof. In some embodiments, the alkali-containing compound includes K₂O, Na₂O, or combinations thereof. In some embodiments, the one or more sorbents includes between about 5% and about 15% by weight alkali-containing compound. In some embodiments, the metal oxide carrier includes porous Al₂O₃. In some embodiments, the substrate further includes a concentration of catalyst, wherein the catalyst includes elemental nickel, ruthenium, or combinations thereof. In some embodiments, the concentration of catalyst in the substrate is between about 0.20% and about 3.0% by weight.

Aspects of the present disclosure are directed to a system for direct air capture of carbon dioxide including, in some embodiments, at least one substrate including an alkali-containing compound dispersed on a metal oxide carrier and a concentration of catalyst. In some embodiments, an ambient air feedstream and an inert gas feedstream in fluid communication with the substrate. In some embodiments, a humidifier is in fluid communication with the inert gas feedstream and the substrate in order to maintain an environment proximate the substrate with a desired moisture content greater than about 1 mol %. In some embodiments, a heat source is also in communication with the substrate. In some embodiments, a product stream including a concentration of carbon dioxide desorbed from the substrate is combined in the system with a hydrogen gas feedstream and contacted with a methanation bed including one or more catalysts disposed on a metal oxide carrier. A methanation product stream including a concentration of methane gas evolved at the methanation bed can then be isolated by and/or from the system.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is a chart of a method for capture of carbon dioxide according to some embodiments of the present disclosure;

FIG. 1B is a chart of a method for capture of carbon dioxide according to some embodiments of the present disclosure;

FIG. 2 is a chart of a method for direct air capture of carbon dioxide according to some embodiments of the present disclosure;

FIG. 3 is a schematic representation of a system for direct air capture of carbon dioxide according to some embodiments of the present disclosure;

FIG. 4 is a schematic representation of a system for capture of carbon dioxide according to some embodiments of the present disclosure;

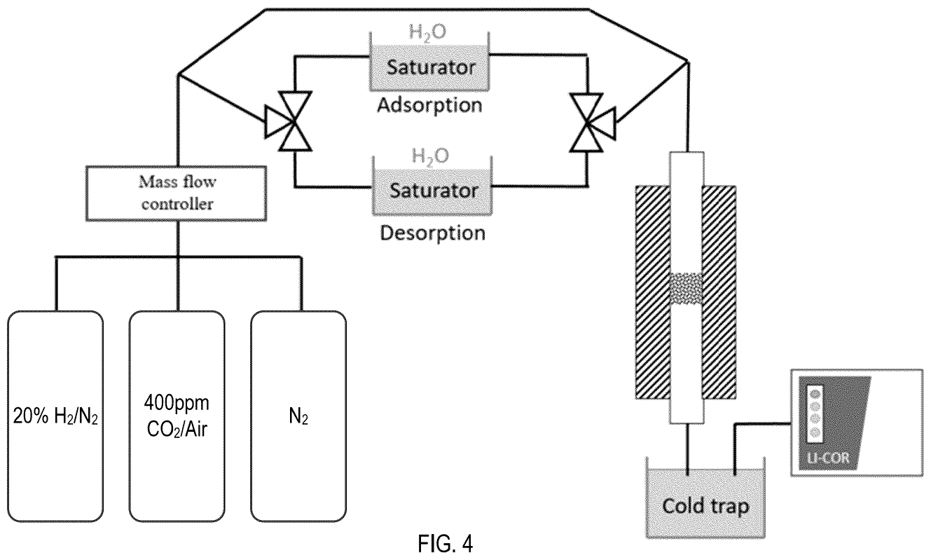

FIG. 5 is a graph portraying adsorption and desorption of carbon dioxide by substrates under moist conditions according to some embodiments of the present disclosure;

FIG. 6A is a graph portraying adsorption and desorption of carbon dioxide by substrates under moist conditions at various temperatures according to some embodiments of the present disclosure;

FIG. 6B is a graph portraying the rate of carbon dioxide desorption from substrates under moist conditions at increasing temperature according to some embodiments of the present disclosure; and

FIG. 7 is a graph portraying sequential cyclic adsorption and desorption of carbon dioxide from substrates under moist conditions according to some embodiments of the present disclosure.

### DETAILED DESCRIPTION

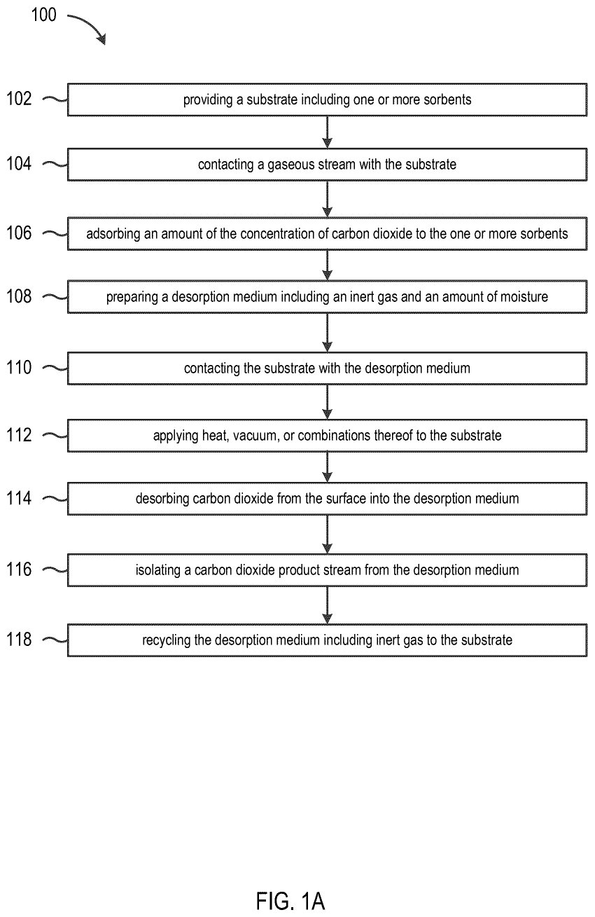

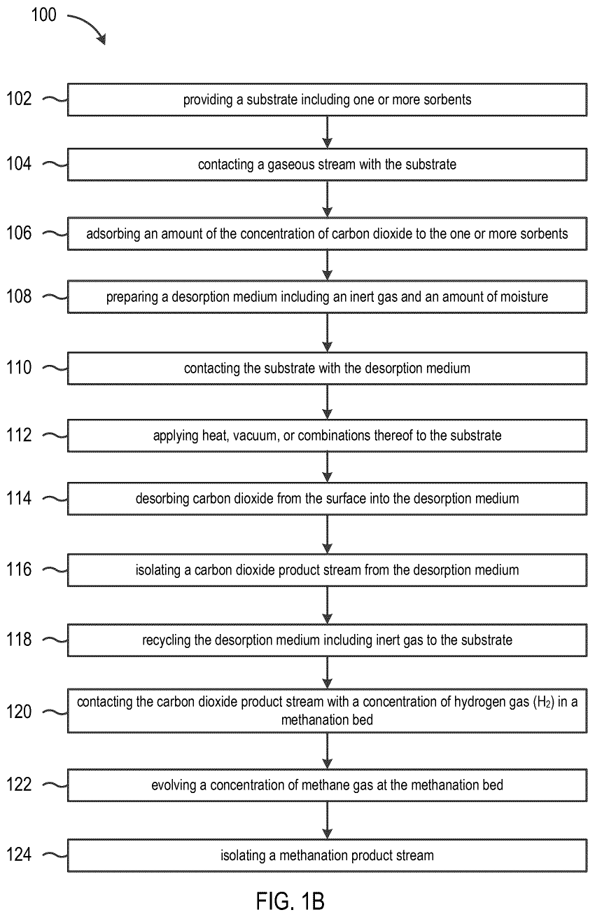

Referring now to FIG. 1A, some embodiments of the present disclosure are directed to a method 100 for capture of carbon dioxide (CO₂). In some embodiments, method 100 is used to capture carbon dioxide from a gaseous medium. In some embodiments, the gaseous medium is produced naturally, produced synthetically, or combinations thereof. In some embodiments, the gaseous medium includes ambient air, gaseous industrial effluents, etc. In some embodiments, the gaseous medium includes at least 50 ppm, 100 ppm, 150 ppm, 200 ppm, 250 ppm, 300 ppm, 350 ppm, 400 ppm, 450 ppm, or 500 ppm carbon dioxide. In some embodiments, the gaseous medium includes more than 500 ppm carbon dioxide.

At 102, a substrate is provided. In some embodiments, the substrate is configured to adsorb carbon dioxide present in the gaseous medium. In some embodiments, the substrate is porous. In some embodiments, the substrate includes a surface. In some embodiments, the substrate includes one or more exterior surfaces. In some embodiments, the substrate includes one or more interior surfaces, e.g., below an exterior surface within a pore in the substrate. In some embodiments, the substrate has a uniform porosity. In some embodiments, the substrate has a higher porosity at a first region and a lower porosity at a second region. In some embodiments, the substrate has a gradient porosity.

In some embodiments, the substrate includes one or more sorbents. In some embodiments, the substrate includes a plurality of sorbents. In some embodiments, the sorbents are porous. In some embodiments, the sorbents include a surface. In some embodiments, the sorbents include one or more exterior surfaces. In some embodiments, the sorbents include one or more interior surfaces, e.g., below an exterior surface within a pore in the sorbent. In some embodiments, the sorbents have a uniform porosity. In some embodiments, the sorbents have a higher porosity at a first region and a lower porosity at a second region. In some embodiments, the sorbents have a gradient porosity.

In some embodiments, the sorbents include one or more a metal oxide compounds dispersed on a carrier. In some embodiments, the metal oxide compound is capable of adsorbing carbon dioxide. In some embodiments, the metal oxide compound is dispersed uniformly. In some embodiments, the metal oxide compound is dispersed at a higher concentration in a first area of the carrier and a lower concentration in at least a second area of the carrier. In some embodiments, the metal oxide compound is nano-dispersed, i.e., the average particle size of the compound dispersed on the carrier is less than about 1 μm. In some embodiments, the metal oxide compound is dispersed on the carrier via any suitable method or combination methods, e.g., an incipient wetness process, a physical vapor deposition process, a chemical vapor deposition process, etc. In some embodiments, the sorbents include an alkali-containing compound dispersed on a carrier. In some embodiments, the alkali-containing compound is dispersed uniformly. In some embodiments, the alkali-containing compound is dispersed at a higher concentration in a first area of the carrier and a lower concentration in at least a second area of the carrier. In some embodiments, the alkali-containing compound is nano-dispersed. In some embodiments, the alkali-containing compound is dispersed on the carrier via any suitable method or combination methods. In some embodiments, the sorbents include between about 5% and about 15% by weight alkali-containing compound. In some embodiments, the sorbents include between about 6% and about 14% by weight alkali-containing compound. In some embodiments, the sorbents include between about 7% and about 13% by weight alkali-containing compound. In some embodiments, the sorbents include between about 8% and about 12% by weight alkali-containing compound. In some embodiments, the sorbents include between about 9% and about 11% by weight alkali-containing compound. In some embodiments, the sorbents include about 10% by weight alkali-containing compound. In some embodiments, the alkali-containing compound includes oxides of potassium, oxides of sodium, other oxides of alkali metals, or combinations thereof. In some embodiments, the alkali-containing compound includes K₂O, Na₂O, or combinations thereof. In some embodiments, the sorbents include an alkaline earth metal-containing compound dispersed on a carrier, e.g., consistent with the embodiments discussed above including particular alkali-containing compounds. In some embodiments, the alkaline earth metal-containing compound includes oxides of calcium, oxides of magnesium, oxides of barium, other oxides of alkaline earth metals, or combinations thereof. In some embodiments, the alkaline earth metal-containing compound includes CaO, MgO, BaO, or combinations thereof. In some embodiments, the metal oxide compound includes CeO₂.

In some embodiments, the carrier is a metal oxide carrier. In some embodiments, the carrier is a porous carrier. In some embodiments, the carrier has a uniform porosity. In some embodiments, the carrier has a higher porosity at a first region and a lower porosity at a second region. In some embodiments, the carrier has a gradient porosity. In some embodiments, the metal oxide carrier includes Al₂O₃.

In some embodiments, the substrate further includes a concentration of catalyst. In some embodiments, the catalyst is included in the sorbents, is separate from the sorbents, or combinations thereof. In some embodiments, the concentration of catalyst in the substrate is between about 0.20% and about 3.0% by weight. In some embodiments, the concentration of catalyst in the substrate is between about 0.25% and about 2.5% by weight. In some embodiments, the concentration of catalyst in the substrate is about 0.25% by weight. In some embodiments, the concentration of catalyst in the substrate is about 0.5% by weight. In some embodiments, the concentration of catalyst in the substrate is about 1.0% by weight. In some embodiments, the concentration of catalyst in the substrate is about 1.5% by weight. In some embodiments, the concentration of catalyst in the substrate is about 2.0% by weight. In some embodiments, the concentration of catalyst in the substrate is about 2.5% by weight. In some embodiments, the concentration of catalyst in the substrate is above about 2.5% by weight. In some embodiments, the catalyst includes elemental nickel, elemental ruthenium, other group 8 catalytic substances, or combinations thereof.

Still referring to FIG. 1A, at 104, a gaseous medium is contacted with the substrate. In some embodiments, the gaseous medium is a gaseous stream. In some embodiments, the gaseous medium includes a concentration of carbon dioxide. As discussed above, in some embodiments, the gaseous medium includes ambient air, gaseous industrial effluents, etc., or combinations thereof. At 106, an amount of carbon dioxide, e.g., from the stream, is adsorbed to the one or more sorbents in the substrate. In some embodiments, at least a portion of carbon dioxide in the stream is adsorbed 106 on a surface of the substrate. In some embodiments, carbon dioxide is adsorbed 106 to an exterior surface of the substrate, an interior surface of the substrate, or combinations thereof. In some embodiments, at least a portion of the concentration of carbon dioxide is adsorbed 106 on an exterior surface of the substrate. In some embodiments, at least a portion of the concentration of carbon dioxide is adsorbed 106 on an interior surface of the substrate, e.g., in a cavity, porous interior of the substrate, etc., or combinations thereof.

In some embodiments, at 108, a desorption medium is prepared. In some embodiments, the desorption medium is composed of one or more components configured to effectuate desorption of at least some of the carbon dioxide adsorbed to the substrate, e.g., at 106, into an environment proximate the substrate. In some embodiments, the desorption medium includes one or more inert gases and an amount of moisture, i.e., a water content greater than 0. In some embodiments, the inert gas is composed of any gas or combination of gases that are at least substantially non-reactive with the as-adsorbed carbon dioxide, the sorbent, the substrate, the catalyst, or combinations thereof. In some embodiments, the inert gas includes nitrogen gas (N₂), hydrogen gas (H₂), or combinations thereof. In some embodiments, the desorption medium includes an amount of moisture sufficient to aid in the desorption of at least a portion of the carbon dioxide from the substrate. In some embodiments, the moisture content of the desorption medium is greater than about 1 mol %. In some embodiments, the moisture content of the desorption medium is between about 1 mol % and about 2 mol %. In some embodiments, the moisture content of the desorption medium is about 2 mol %. In some embodiments, the moisture content of the desorption medium is greater than about 2 mol %.

In some embodiments, at 110, the substrate with adsorbed carbon dioxide is contacted with an amount of desorption medium. At 112, heat, vacuum, or combinations thereof are applied to the substrate. While this embodiment of method 100 describes contacting 110 as being performed prior to applying 112, the present disclosure is not intended to be limiting in this regard, as those of skill in the art will understand that applying 112 can be performed before contacting 110, steps 110 and 112 can be performed concurrently or at least partially concurrently, etc. Contacting 110 and applying 112 can be performed in any suitable vessel, as will be discussed in greater detail below. In some embodiments, contacting 110 and applying 112 are performed in separate vessels. In some embodiments, applying 112 includes directly heating the substrate, heating an environment surrounding the substrate, heating the desorption medium, or combinations thereof. In some embodiments, applying 112 includes heating one or more surfaces of the substrate to a target temperature. In some embodiments, the target temperature is less than about 200° C. In some embodiments, the target temperature is between about 75° C. and about 200° C. In some embodiments, the target temperature is 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or 200° C.

At 114, carbon dioxide is desorbed, e.g., from sorbents at an exterior surface of the substrate. In some embodiments, carbon dioxide is desorbed 114 into the desorption medium. At 116, a carbon dioxide product is isolated. In some embodiments, a carbon dioxide product stream is isolated at 116. In some embodiments, the carbon dioxide product is isolated 116 from the desorption medium. The moisture content of the desorption medium causes significantly more carbon dioxide to desorb from the substrate compared with a dry desorption medium. This increased desorption efficiency not only facilitates isolation 116 of more carbon dioxide, but also allows the heat applied at 112 to be reduced, as will be discussed in greater detail below. Without wishing to be bound by theory, it is believed that moisture content consistent with embodiments of the present disclosure can catalyze alkali-carbonate decomposition in the substrate, releasing additional carbon dioxide and increasing overall yield and production rate of CO₂ even at lower temperatures, particularly as compared with dry desorption conditions, as will be demonstrated below. In some embodiments, at 118, at least a portion of the desorption medium is recycled to the substrate, e.g., inert gas is recycled after being separated from the carbon dioxide product to desorb additional carbon dioxide from the substrate.

Referring now to FIG. 1B, in some embodiments of method 100, at 120, at least a portion of the carbon dioxide product isolated at 116, e.g., carbon dioxide product stream, is contacted with a concentration of hydrogen gas (H₂). At 122, the CO₂/H₂ mixture is contacted with a hydrogenation bed. In some embodiments, the hydrogenation bed includes one or more components to generate an amount of a hydrocarbyl product from CO₂ and H₂ reactants from contacting 120. In some embodiments, the hydrocarbyl bed is a packed bed. In some embodiments, the hydrocarbyl bed includes one or more catalysts disposed on a carrier. In some embodiments, the catalysts include any catalyst or combination of catalysts configured to generation the desired hydrocarbyl product from the CO₂ and H₂ reactants. In some embodiments, the catalysts include elemental nickel, elemental ruthenium, Cu-containing materials, or combinations thereof. In some embodiments, the carrier includes AlO₃. In some embodiments, the hydrocarbyl product includes methane, methanol, carbon monoxide, etc., or combinations thereof. In some embodiments, the hydrocarbyl bed is a methanation bed.

At 124, a concentration of hydrocarbyl product, e.g., methane gas, is evolved at the hydrogenation bed. In some embodiments, at 126, a hydrocarbyl product stream, e.g., a methanation product stream, is isolated. In some embodiments, the methanation product stream includes a concentration of the methane gas evolved at the methanation bed in 124.

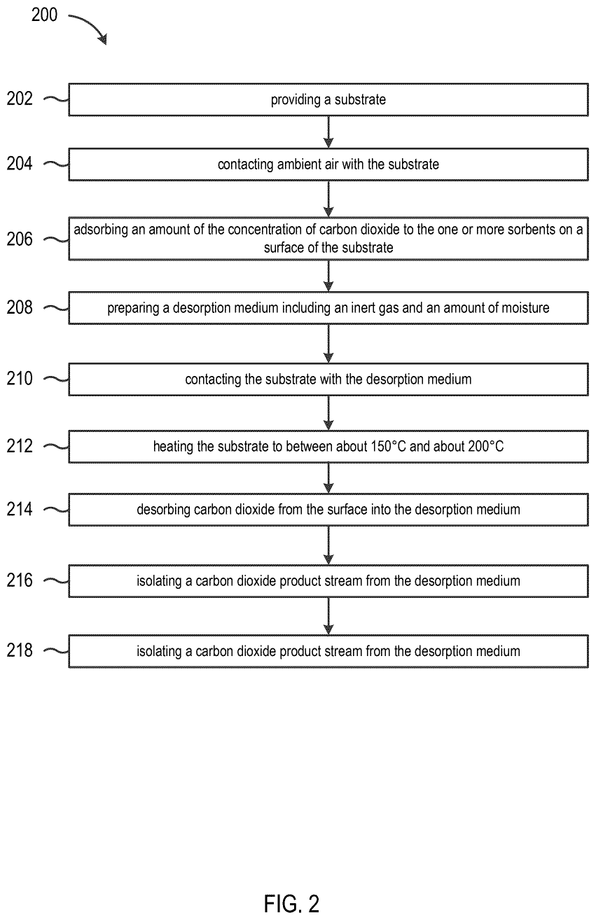

Referring now to FIG. 2, a method 200 for direct air capture of carbon dioxide consistent with some embodiments of the present disclosure is shown. In some embodiments, at 202, a substrate is provided. As discussed above, the substrate includes one or more sorbents. In some embodiments, the sorbents include one or more a metal oxide compounds dispersed on a carrier. In some embodiments, the metal oxide compound is capable of adsorbing carbon dioxide. In some embodiments, the one or more sorbents include an alkali-containing compound dispersed on a metal oxide carrier and a concentration of catalyst. In some embodiments, the alkali-containing compound includes K₂O, Na₂O, or combinations thereof. In some embodiments, the one or more sorbents include an alkaline earth metal-containing compound dispersed on a metal oxide carrier and a concentration of catalyst. In some embodiments, the alkaline earth metal-containing compound includes CaO, MgO, BaO, or combinations thereof. In some embodiments, the metal oxide compound includes CeO₂. In some embodiments, the metal oxide carrier includes porous Al₂O₃. In some embodiments, the catalyst includes elemental nickel, elemental ruthenium, or combinations thereof.

In some embodiments, at 204, ambient air including a concentration of carbon dioxide is contacted with the substrate. In some embodiments, at 206, an amount of the concentration of carbon dioxide is adsorbed to the one or more sorbents on a surface of the substrate. In some embodiments, at 208, a desorption medium including an inert gas and an amount of moisture to desorb the carbon dioxide is prepared. In some embodiments, the inert gas includes nitrogen gas (N₂), hydrogen gas (H₂), or combinations thereof. In some embodiments, the moisture content of the desorption medium is greater than about 1 mol %. In some embodiments, the moisture content of the desorption medium is between about 1 mol % and about 2 mol %. In some embodiments, the moisture content of the desorption medium is about 2 mol %. In some embodiments, the moisture content of the desorption medium is greater than about 2 mol %.

In some embodiments, at 210, the substrate is contacted with the desorption medium. In some embodiments, at 212, the substrate is heated. In some embodiments, the substrate is heated 212 to less than about 200° C. In some embodiments, the substrate is heated 212 to between about 75° C. and about 200° C. In some embodiments, the substrate is heated 212 to 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or 200° C. In some embodiments, at 214, carbon dioxide is desorbed from the surface into the desorption medium. In some embodiments, at 216, a carbon dioxide product stream is isolated from the desorption medium.

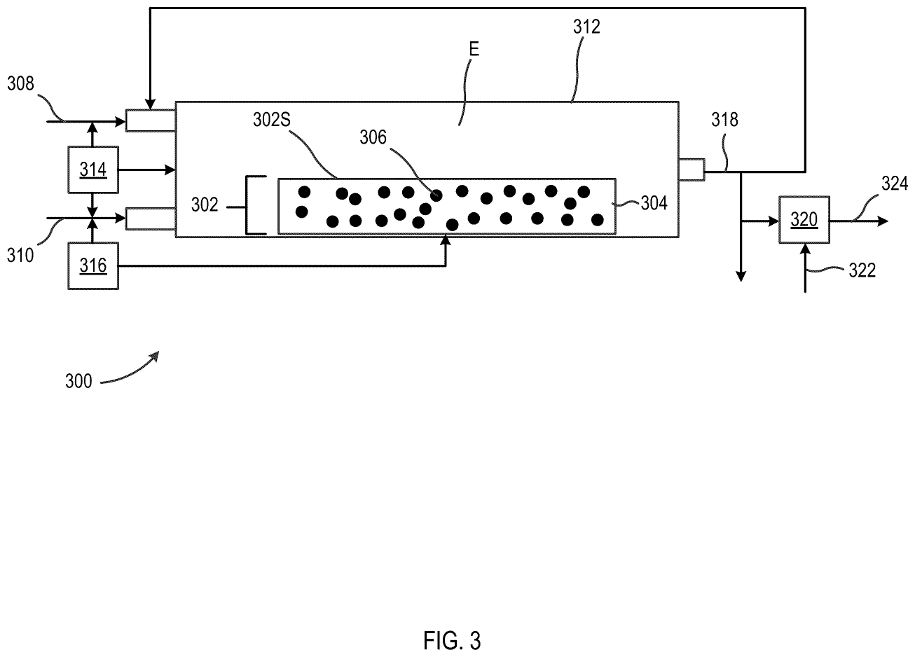

Referring now to FIG. 3, some embodiments of the present disclosure are directed to a system 300 for capture of carbon dioxide from a gaseous medium, e.g., direct air capture. In some embodiments, system 300 includes at least one substrate 302. In some embodiments, substrate 302 is porous. In some embodiments, substrate 302 has a uniform porosity. In some embodiments, substrate 302 has a higher porosity at a first region and a lower porosity at a second region. In some embodiments, substrate 302 has a gradient porosity. In some embodiments, substrate 302 includes one or more surfaces 302S. In some embodiments, surfaces 302S include one or more exterior surfaces, interior surfaces, or combinations thereof. As discussed above, in some embodiments, substrate 302 includes one or more sorbents. In some embodiments, substrate 302 is a monolithic substrate upon which one or more sorbents are bound. In some embodiments, substrate 302 includes a plurality of sorbents 304. In some embodiments, sorbents 304 are porous. In some embodiments, sorbents 304 are porous. In some embodiments, sorbents 304 have a uniform porosity. In some embodiments, sorbents 304 have a higher porosity at a first region and a lower porosity at a second region. In some embodiments, sorbents 304 have a gradient porosity.

In some embodiments, sorbents 304 include one or more a metal oxide compounds dispersed on a carrier. In some embodiments, the metal oxide compound is capable of adsorbing carbon dioxide. In some embodiments, sorbents 304 include an alkali-containing compound dispersed on a carrier. In some embodiments, the alkali-containing compound is dispersed uniformly within the carrier. In some embodiments, the alkali-containing compound is dispersed at a higher concentration in a first area of the carrier and a lower concentration in at least a second area of the carrier. In some embodiments, the alkali-containing compound is nano-dispersed. In some embodiments, sorbents 304 include between about 5% and about 15% by weight alkali-containing compound. In some embodiments, sorbents 304 include between about 6% and about 14% by weight alkali-containing compound. In some embodiments, sorbents 304 include between about 7% and about 13% by weight alkali-containing compound. In some embodiments, sorbents 304 include between about 8% and about 12% by weight alkali-containing compound. In some embodiments, sorbents 304 include between about 9% and about 11% by weight alkali-containing compound. In some embodiments, sorbents 304 include between about 10% by weight alkali-containing compound. In some embodiments, the alkali-containing compound includes oxides of potassium, oxides of sodium, other oxides of alkali metals, or combinations thereof. In some embodiments, the alkali-containing compound includes K₂O, Na₂O, or combinations thereof. In some embodiments, sorbents 304 include an alkaline earth metal-containing compound dispersed on a carrier, e.g., consistent with the embodiments discussed above including particular alkali-containing compounds. In some embodiments, the alkaline earth metal-containing compound includes oxides of calcium, oxides of magnesium, oxides of barium, other oxides of alkaline earth metals, or combinations thereof. In some embodiments, the alkaline earth metal-containing compound includes CaO, MgO, BaO, or combinations thereof. In some embodiments, the metal oxide compound includes CeO₂.

In some embodiments, the carrier is a metal oxide carrier. In some embodiments, the carrier is a porous carrier. In some embodiments, the carrier has a uniform porosity. In some embodiments, the carrier has a higher porosity at a first region and a lower porosity at a second region. In some embodiments, the carrier has a gradient porosity. In some embodiments, the metal oxide carrier includes porous Al₂O₃.

In some embodiments, substrate 302 further includes a concentration of catalyst 306. In some embodiments, catalyst 306 is included in the sorbents, is separate from the sorbents, or combinations thereof. In some embodiments, the concentration of catalyst 306 in substrate 302 is between about 0.20% and about 3.0% by weight. In some embodiments, the concentration of catalyst 306 in substrate 302 is between about 0.25% and about 2.5% by weight. In some embodiments, the concentration of catalyst 306 in substrate 302 is about 0.25% by weight. In some embodiments, the concentration of catalyst 306 in substrate 302 is about 0.5% by weight. In some embodiments, the concentration of catalyst 306 in substrate 302 is about 1.0% by weight. In some embodiments, the concentration of catalyst 306 in substrate 302 is about 1.5% by weight. In some embodiments, the concentration of catalyst 306 in substrate 302 is about 2.0% by weight. In some embodiments, the concentration of catalyst 306 in substrate 302 is about 2.5% by weight. In some embodiments, the concentration of catalyst 306 in substrate 302 is greater than about 2.5% by weight. In some embodiments, catalyst 306 includes elemental nickel, elemental ruthenium, other group 8 catalytic substances, or combinations thereof.

Still referring now to FIG. 3, in some embodiments, system 300 includes a gaseous feedstream 308. In some embodiments, gaseous feedstream 308 is in fluid communication with substrate 302. In some embodiments, gaseous feedstream 308 includes one or more gaseous media. As discussed above, in some embodiments, the gaseous media include ambient air, gaseous industrial effluents, etc. In some embodiments, system 300 includes an inert gas feedstream 310. In some embodiments, inert gas feedstream 310 is in fluid communication with substrate 302. As discussed above, in some embodiments, inert gas feedstream 310 includes one or more inert gases. In some embodiments, the inert gases include N₂, H₂, or combinations thereof.

In the embodiment shown in FIG. 3, substrate 302 is positioned within a vessel 312 and feedstreams 308 and 310 are provided to the vessel to contact substrate 302. In these embodiments, vessel 312 and substrate 302 can have any suitable size and configuration to facilitate contact between substrate 302 and feedstreams 308 and 310, e.g., for adsorption of carbon dioxide. However, the present disclosure is not intended to be limited to this arrangement, as substrate 302 may also or instead be exposed to a surrounding environment which includes the components of gaseous feedstream 308 and/or inert gas feedstream 310, e.g., in some embodiments where system 300 is used to capture carbon dioxide directly from ambient air.

Referring again to FIG. 3, in some embodiments, system 300 includes a humidifier 314. Humidifier is configured to provide and/or maintain an environment E proximate substrate 302, e.g., at surface 302S, at a predetermined moisture content. In some embodiments, humidifier 312 is in fluid communication with and configured to provide moisture to feedstream 308, feedstream 310, vessel 312, environment E, etc., or combinations thereof. As discussed above, in some embodiments, humidifier is configured to provide and/or maintain a desired moisture content, e.g., in inert gas feedstream 310, greater than about 1 mol %; between about 1 mol % and about 2 mol %; at about 2 mol %; or greater than about 2 mol %.

In some embodiments, system 300 includes a heat source 316. In some embodiments, heat source 316 is in communication with substrate 302. As discussed above, in some embodiments, heat source 316 directly heats substrate 302; heats an environment surrounding the substrate, e.g., environment E; heats feedstream 310, or combinations thereof, in order to heat the surface to which carbon dioxide is adsorbed, e.g., surface 302S. In some embodiments, heat source 316 is configured to apply heat at or at least a portion of heat substrate 302 to, e.g., surface 304S, a target temperature. In some embodiments, the target temperature is less than about 200° C. In some embodiments, the target temperature is between about 75° C. and about 200° C. In some embodiments, the target temperature is 75° C., 80° C., 85° C., 90° C., 95° C., 100° C., 105° C., 110° C., 115° C., 120° C., 125° C., 130° C., 135° C., 140° C., 145° C., 150° C., 155° C., 160° C., 165° C., 170° C., 175° C., 180° C., 185° C., 190° C., 195° C., or 200° C. In some embodiments, system 300 includes a product stream 318. In some embodiments, product stream 318 includes a concentration of carbon dioxide desorbed from substrate 302, desorbed from sorbents at surface 302S.

In some embodiments, at least a portion of product stream 318 is provided to a hydrogenation bed 320, e.g., a methanation bed. As discussed above, in some embodiments, hydrogenation bed 320 includes one or more catalysts disposed on a carrier, e.g., a metal oxide carrier. In some embodiments, the catalysts include any catalyst or combination of catalysts configured to generation the desired hydrocarbyl product from the CO₂ and H₂ reactants. In some embodiments, at least a portion of product stream 318 is combined with a hydrogen gas feedstream 322. In some embodiments, at least a portion of product stream 318 is combined with H₂ feedstream 322 prior to contact with hydrogenation bed 320, at the hydrogenation bed, or combinations thereof. In some embodiments, a hydrogenation product stream 324 including a concentration of hydrocarbyl product is evolved at hydrogenation bed 320. In some embodiments, the hydrocarbyl product includes methane, methanol, carbon monoxide, etc., or combinations thereof. In some embodiments, hydrogenation product stream 324 is isolated, e.g., to be sold as a standalone product of system 300. In some embodiments, at least a portion of product stream 318 is recycled to inert gas feedstream 310, substrate 302, or combinations thereof.

### EXAMPLE

In an exemplary embodiment, substrates including sorbent materials were prepared. An aqueous solution of sodium carbonate (Na₂CO₃) was impregnated into 300 m γ-Al₂O₃ granules (Sasol TH100)) using an incipient wetness method. To reach the target loading (10% “Na₂O”), multiple impregnation steps were used. Between each step, the sample was dried at 120° C. for 4 hours in static air. When the sorbent was fully loaded it was calcined at 400° C. for 4 hours in static air to ensure adherence.

A catalytic metal was included in the preparation to increase the extent of the Na₂CO₃ decomposition, enhancing CO₂ adsorption. To incorporate Ru into the substrate, an aqueous solution of ruthenium nitrosyl nitrate (Ru(NO)(NO₃)₃) precursor salt (Alfa Aesar™ containing 32% Ru) was impregnated to achieve a loading of 0.25% Ru. In other examples, nickel nitrate hexahydrate (Ni(NO₃)₂·6H₂O) dissolved in water salt (Sigma Aldrich®, Ni 99.9%) was used as a substitute for Ru since Ni metal is also capable of decomposing Na₂CO₃ during the H₂ pre-treatment. For each example, a salt was added to DI H₂O and added dropwise to the pre-calcinated sample. In some embodiments, the final loading was 0.25% Ru, 1% Ni, or 2.5% Ni loading. The combinations were dried at 120° C. for 4 hours in static air. It was desired to avoid oxidation of the Ni since its reduced state will catalytically decompose the Na₂CO₃ to “Na₂O.” The sample was then fixed in the reactor and subjected to flowing 20% H₂/N₂ for pre-reduction at 350° C. for 20 hours with a heat up of 5° C./min. During the pre-treatment, CH₄ is measured by an Enerac 700 analyzer confirming decomposition of some of the dispersed Na₂CO₃. The final example materials were composed of either 0.25% Ru, or 1 or 2.5% Ni dispersed on 10% “Na₂O”/Al₂O₃//granules.

Direct air capture and desorption procedures were conducted. Three cylinders (100% N₂, 20% H₂/N₂, and 400 ppm CO₂ in air) were connected to three discrete mass flow meters connected to a three-way valve establishing the desired gas flow path. This arrangement allowed for humid adsorption of the feed gas (simulating ambient humidity) and for moist or dry desorption in N₂. Two separate saturators were used since the capture feed gas path became saturated with CO₂ while the desorption path provided the desorbed CO₂ product stream. Gas flow through the water saturator for both humid adsorption and moist desorption generated at 20° C. resulted in about 2 mol % moisture. Adsorption steps were conducted at 20° C. with 2 mol % moisture with 400 ml/min simulated air gas containing 400 ppm CO₂. Moisture in the exit gases was condensed in the cold trap before entering an CO₂/H₂O analyzer.

A quartz tube (O.D.=12.75 mm, I.D=10.5 mm, L=500 mm) was located within a Mellon Microtherm™ furnace equipped with a temperature controller. The sample thermocouple (Omega™ Type K) was positioned at the inlet center of sample bed supported by glass wool (Supelco™). The void volume in the reactor tube was filled with glass beads (4 mm McKesson™) to reduce the dead volume for more rapid analysis.

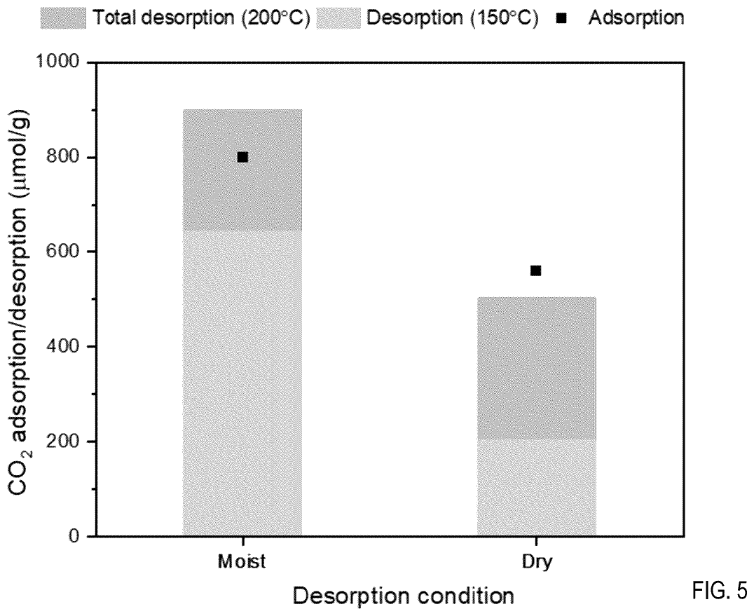

Referring now to FIG. 5, the viability of a moisture-containing feedstream for adsorption and desorption in a temperature swing operation consistent with embodiments of the present disclosure was evaluated in a series of tests using a sorbent sample of 0.25% Ru with 10% “Na₂O”/Al₂O₃. The enhancement of CO₂ adsorption capacity in the presence of moist air (2 mol %) was shown as black dots. Without wishing to be bound by theory, the addition of moisture to the feed is believed to convert nano-dispersed “Na₂O”/Al₂O₃ to nano-dispersed 2NaHCO₃/Al₂O₃ with a high CO₂ sorption capacity of 899.8 μmole/g (left) relative to desorption in a dry inert purge gas 503.7 μmole/g (right).

Table 1 presents the results from FIG. 5. Both adsorption tests were conducted under humid conditions (20° C., 400 ppm CO₂/air with 2 mol % H₂O). Moist desorption (2 mol % H₂O) produced a higher CO₂ capacity than dry desorption during heating from ambient to elevated temperatures (150° C. and 200° C.). For example, at 150° C., a moist desorption condition exhibits an efficiency that is threefold greater than that of the dry desorption condition.

TABLE 1
The amount of adsorbed and desorbed CO₂ using 0.25%
Ru, 10% “Na₂O”/Al₂O₃ with 400 ml/min air containing 400
ppm CO₂ and 2 mol % H₂O.

| | | Temper- | Temper- | Fraction |
|---|---|---|---|---|
| | Steady State | ature | ature | (150° C./ |
| Unit (μmol/g) | (2 mol % H₂O) | (150° C.) | (200° C.) | 200° C.) |
| Adsorption | 719.43 | | | |
| Moist | | 643.64 | 899.80 | 71.5 |
| Desorption | | | | |
| Adsorption | 559.43 | | | |
| Dry Desorption | | 203.49 | 503.71 | 40.4 |

Table 2 shows the integrated amount and fractions of CO₂ desorbed (relative to the amount adsorbed) with and without moisture present at the various temperature increments. From 25° C. to 100° C., the amount of desorbed CO₂ is 190.89 μmols under moist desorption conditions compared to 99.95 μmols under dry desorption conditions. This trend continues as the temperature increments for desorption continue up to 200° C., demonstrating desorption of about 900 μmols for moist desorption conditions compared to 504 μmols for dry desorption conditions.

TABLE 2
The amount of CO₂ desorbed at each temperature range reported
as capacity (μmol/g) and fraction (% of adsorbed CO₂) using
0.25% Ru, 10% “Na₂O”/Al₂O₃.

| | Moist Desorption Condition | | | Dry Desorption Condition | | |
|---|---|---|---|---|---|---|
| Tem- | Desorbed | Integrated | | Desorbed | Integrated | Frac- |
| perature | CO₂ | desorbed | Fraction | CO₂ | desorbed | tion |
| (° C.) | (μmol/g) | CO₂ | (%) | (μmol/g) | CO₂ | (%) |
| 25-100 | 190.89 | 190.89 | 21.21 | 99.95 | 99.95 | 19.84 |
| 100-125 | 207.12 | 398.02 | 23.02 | 40.62 | 140.58 | 8.06 |
| 125-150 | 245.60 | 643.62 | 27.3 | 62.92 | 203.49 | 12.49 |
| 150-175 | 155.30 | 798.93 | 17.25 | 106.05 | 309.55 | 21.05 |
| 175-200 | 100.88 | 899.80 | 11.21 | 194.16 | 503.71 | 38.54 |
| Total | | | 100 | | | 100 |

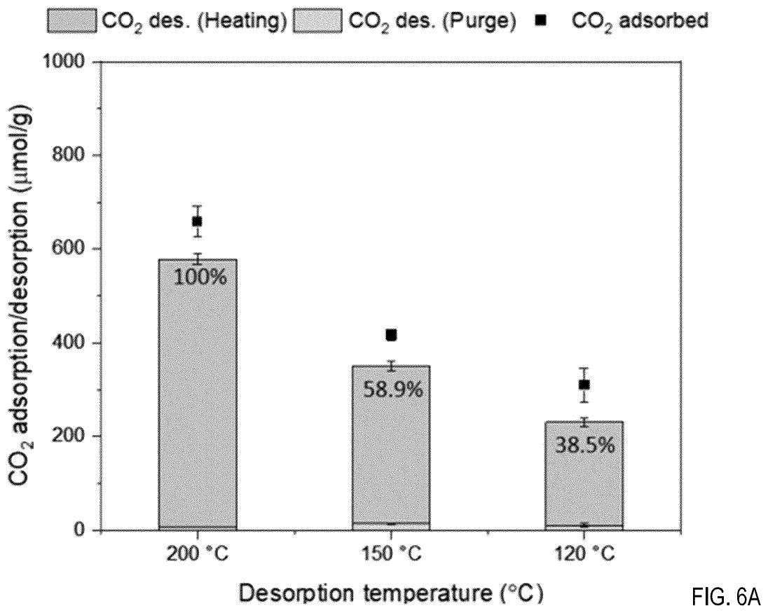

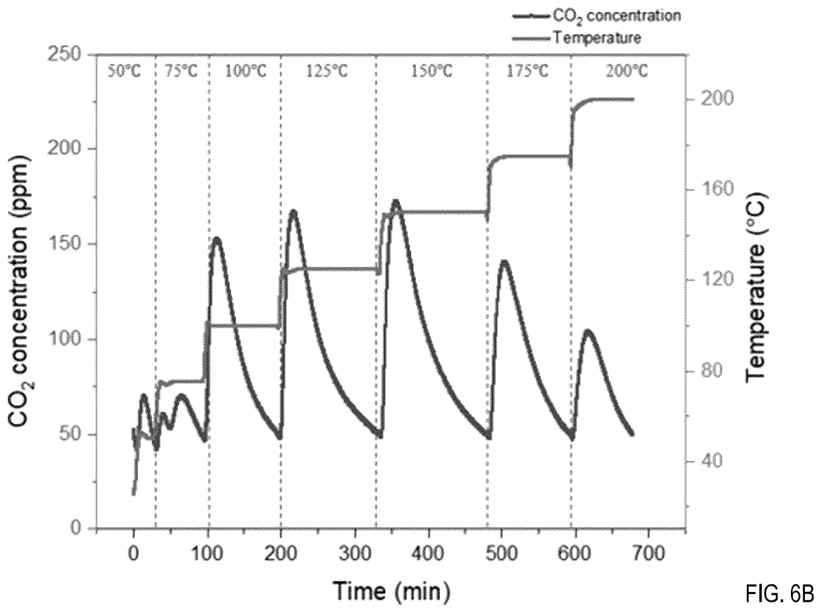

Referring now to FIGS. 6A-6B, 2.5% Ni was used to replace 0.25% Ru, and moist desorption conditions were tested at three different temperatures (120° C., 150° C., and 200° C.) using 2.5% Ni, 10% “Na₂O”/Al₂O₃. When desorbing CO₂, the appropriate temperature can be set according to a desired energy consumption. For example, it can be advantageous to set a higher desorption temperature to improve yield of desorbed CO₂, although potentially at the expense of higher energy consumptions.

The adsorption capacity decreases with lower desorption temperatures due to the retained CO₂ on the alkali sorbent sites, despite the same adsorption conditions. At 200° C., almost 100% of the adsorbed CO₂ is desorbed, compared to 38.5% at 120° C. and 58.9% at 150° C., indicating that the system can operate at lower temperatures, thus consuming less energy but with a lower yield of CO₂. FIG. 6B illustrates the rate of moist desorption from 25° C. to 200° C.

Table 3 shows adsorption, purge, and desorption in systems consistent with the present disclosure at three different temperatures. It can be seen that the capacity of adsorption and moist desorption decreases as the temperature is reduced.

TABLE 3
Adsorption, purge, and desorption capabilities of 2.5% Ni, 10%
“Na₂O”/Al₂O₃ at three different desorption temperatures under
moist condition (100 ml/min N₂, 5° C./min, and 2 mol % H₂O).

| | Desorption | Desorption | Desorption |
|---|---|---|---|
| Unit (μmol/g) | at 200° C. | at 150° C. | at 120° C. |
| Adsorption | 658.9 | 416.3 | 309.3 |
| Desorption | 572.1 | 337.2 | 220.1 |

Table 4 shows the fractions of CO₂ desorbed with and without moisture present at the various temperature increments. The total moist desorption capacities in these Ni-containing embodiments were lower than the Ru-containing embodiments (Table 2), but confirmed that nickel can replace ruthenium as a catalyst in the substrates consistent with embodiments of the present disclosure.

TABLE 4
The amount of CO₂ desorbed at each temperature ranges is reported
as capacity (μmol/g) and fraction (%) using
2.5% Ni, 10% “Na₂O”/Al₂O₃.

| | Moist Desorption Condition | | | Dry Desorption Condition | | |
|---|---|---|---|---|---|---|
| Tem- | Desorbed | Integrated | | Desorbed | Integrated | Frac- |
| perature | CO₂ | desorbed | Fraction | CO₂ | desorbed | tion |
| (° C.) | (μmol/g) | CO₂ | (%) | (μmol/g) | CO₂ | (%) |
| 25-100 | 160.65 | 160.65 | 28.2 | 90.90 | 90.90 | 27.32 |
| 100-125 | 124.83 | 285.48 | 21.91 | 27.12 | 118.02 | 8.15 |
| 125-150 | 122.88 | 408.36 | 21.57 | 43.05 | 161.06 | 12.94 |
| 150-175 | 84.81 | 493.17 | 14.89 | 71.60 | 232.66 | 21.52 |
| 175-200 | 76.44 | 569.61 | 13.42 | 100.74 | 333.39 | 30.27 |
| Total | | | 100 | | | 100 |

These results showed minor differences in yield of CO₂ between 2 mol % and 1 mol % moisture (572.1 μmol/g vs 664.1 μmol/g). However, below 1 mol %, the capacity of desorption decreased (417.7 μmol/g) to a much greater extent.

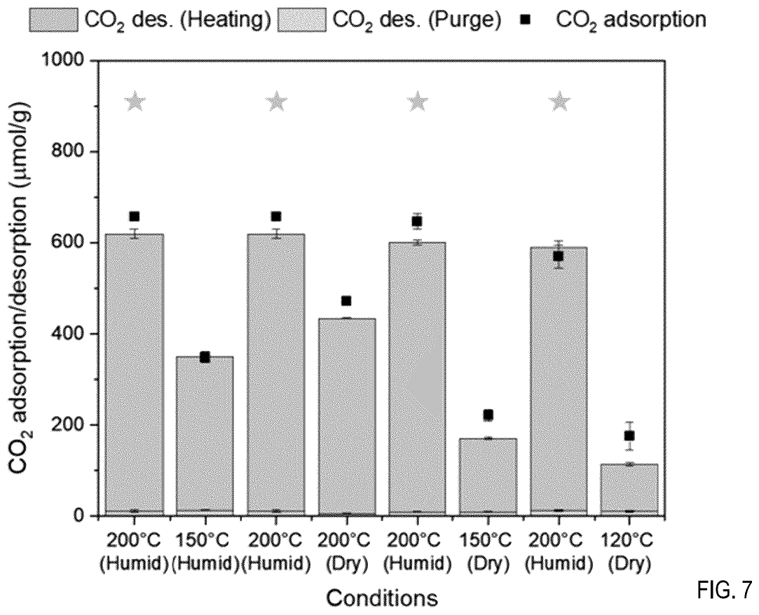

Systems and methods of the present disclosure advantageously provide sorbents for capture of trace amounts of carbon dioxide from gaseous media, including direct air capture. Sorbent substrates consistent with embodiments of the present disclosure, for example those composed of 2.5% Ni, 10% “Na₂O”/Al₂O₃, provide an improvement in both CO₂ adsorption and desorption processes. The presence of moist desorption conditions, e.g., 2 mol % moisture, enhances the yield of CO₂ and at a higher rate relative to dry desorption condition purges. These benefits are realized at lower temperatures than dry adsorption conditions, and at the vapor pressure of water at 25° C. for desorption, greatly decreasing the energy costs associated with the desorption and recovery of the adsorbed carbon dioxide. The low partial pressure of moisture avoids the generation of steam, a method used for desorbing CO₂ from sorbent solids and aqueous amine solutions, and its associated energy penalty. Referring specifically to FIG. 7, a 60-cycle aging study of low moisture content-assisted desorption consistent with embodiments of the present disclosure at varying desorption temperatures, e.g., 120° C., 150° C., 200° C., confirmed the stability of the substrates and longer-term viability of those substrates for direct air capture.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A method for capture of carbon dioxide, comprising:
providing a substrate including one or more sorbents, wherein the one or more sorbents includes a metal oxide compound dispersed on a metal oxide carrier, wherein the metal oxide compound is capable of adsorbing carbon dioxide;
contacting a gaseous stream with the substrate, the gaseous stream including a concentration of carbon dioxide;
adsorbing an amount of the concentration of carbon dioxide to the one or more sorbents;
preparing a desorption medium including an inert gas and an amount of moisture to desorb the carbon dioxide;
contacting the substrate with the desorption medium; and
applying heat, vacuum, or combinations thereof to the substrate,
wherein a moisture content of the desorption medium is greater than about 1 mol %.

2. The method according to claim 1, further comprising:
desorbing carbon dioxide from the sorbents into the desorption medium; and
isolating a carbon dioxide product stream from the desorption medium.

3. The method according to claim 1, wherein the inert gas includes nitrogen gas (N₂).

4. The method according to claim 1, wherein the one or more sorbents includes an alkali-containing compound.

5. The method according to claim 4, wherein the alkali-containing compound includes K₂O, Na₂O, or combinations thereof.

6. The method according to claim 4, wherein the one or more sorbents includes between about 5% and about 15% by weight alkali-containing compound.

7. The method according to claim 1, wherein the one or more sorbents includes an alkaline earth metal-containing compound.

8. The method according to claim 7, wherein the alkaline earth metal-containing compound includes CaO, MgO, BaO, or combinations thereof.

9. The method according to claim 1, wherein the metal oxide carrier includes porous Al₂O₃.

10. The method according to claim 1, wherein the substrate further includes a concentration of catalyst, wherein the catalyst includes elemental nickel, ruthenium, or combinations thereof.

11. The method according to claim 10, wherein the concentration of catalyst in the substrate is between about 0.20% and about 3.0% by weight.

12. The method according to claim 1, wherein the substrate is heated to a temperature between about 75° C. and about 200° C.

13. The method according to claim 12, wherein the substrate is heated to a temperature of about 150° C.

14. The method according to claim 2, further comprising:
contacting the carbon dioxide product stream with a concentration of hydrogen gas (H₂) in a hydrogenation bed including one or more catalysts disposed on a metal oxide carrier;
evolving a concentration of a hydrocarbyl product at the hydrogenation bed; and
isolating a hydrogenation product stream, including a concentration of the hydrocarbyl product evolved at the hydrogenation bed.

15. The method according to claim 14, wherein the hydrocarbyl product includes methane, methanol, carbon monoxide, or combinations thereof.

16. The method according to claim 1, wherein the moisture content of the desorption medium is about 2 mol %.

17. A method for direct air capture of carbon dioxide, comprising:
providing a substrate, including:
one or more sorbents, wherein the one or more sorbents includes an alkali-containing compound dispersed on a metal oxide carrier; and
a concentration of catalyst,
contacting ambient air with the substrate, the ambient air including a concentration of carbon dioxide;
adsorbing an amount of the concentration of carbon dioxide to the one or more sorbents on a surface of the substrate;
preparing a desorption medium including an inert gas and an amount of moisture to desorb the carbon dioxide;
contacting the substrate with the desorption medium;
heating the substrate to between about 150° C. and about 200° C.;
desorbing carbon dioxide from the surface into the desorption medium; and
isolating a carbon dioxide product stream from the desorption medium,
wherein a moisture content of the desorption medium is greater than about 1 mol %.

18. The method according to claim 17, wherein the inert gas includes nitrogen gas (N₂), the alkali-containing compound includes K₂O, Na₂O, or combinations thereof, the metal oxide carrier includes porous Al₂O₃, and the catalyst includes elemental nickel, ruthenium, or combinations thereof.

19. The method according to claim 17, wherein the moisture content of the desorption medium is about 2 mol %.

20. A system for direct air capture of carbon dioxide, comprising:
at least one substrate, including:
one or more sorbents dispersed on a metal oxide carrier; and
a concentration of catalyst,
wherein the one or more sorbents include:
an alkali-containing compound including K₂O, Na₂O, or
combinations thereof,
an alkaline earth metal-containing compound including CaO, MgO, BaO, or combinations thereof,
or combinations thereof,
the metal oxide carrier includes porous Al₂O₃, and the catalyst includes elemental nickel, ruthenium, or combinations thereof,
an ambient air feedstream in fluid communication with the at least one substrate;
an inert gas feedstream in fluid communication with the at least one substrate;
a humidifier in fluid communication with the inert gas feedstream and the at least one substrate, the humidifier configured to maintain an environment proximate the at least one substrate with a moisture content greater than about 1 mol %;
a heat source in communication with the substrate, and
a product stream including a concentration of carbon dioxide desorbed from the substrate.

21. The system according to claim 20, further comprising:
a hydrogen gas feedstream;
a methanation bed including one or more catalysts disposed on a metal oxide carrier, the methanation bed positioned so as to be in communication with the product feedstream and hydrogen gas from the hydrogen gas feedstream; and
a methanation product stream, including a concentration of methane gas evolved at the methanation bed.
